(19) United States
(12) Patent Application Publication
(10) Pub. No.: US 2025/0251743 A1
(43) Pub. Date: Aug. 7, 2025

(54) SYSTEMS AND METHODS FOR ANALYZING PERFORMANCE OF AN AUTONOMOUS ROBOT SYSTEM

(71) Applicant: Kabushiki Kaisha Toshiba, Tokyo (JP)

(72) Inventors: Xiaotao SHAN, Bristol (GB); Yichao JIN, Bristol (GB)

(73) Assignee: Kabushiki Kaisha Toshiba, Tokyo (JP)

(21) Appl. No.: 18/434,446

(22) Filed: Feb. 6, 2024

(51) Int. Cl. G05D 1/86; B65G 1/137; G05D 1/667; G05D 107/70; G06Q 10/087

(52) U.S. Cl. CPC G05D 1/86; B65G 1/1373; G05D 1/667; G06Q 10/087; G05D 2107/70

(57) ABSTRACT

Systems and methods for estimating performance of an autonomous robot system that is configured to fulfil multiple line orders is described herein. The autonomous robot system comprises a plurality of autonomous guided vehicles configured to transport one or more cases within an environment so as to fulfil the multiple line orders. In some variations, a method includes obtaining first input data, generating a simulation model based at least in part on the first input data, determining a travel duration for each of the plurality of autonomous guided vehicles based on an execution of the simulation model, generating an analytical model based at least in part on the travel duration, and estimating the performance of the autonomous robot system based on an execution of the analytical model. The first input data includes data associated with operation of each of the plurality of autonomous guided vehicles and data representing a layout of the environment.

### TECHNICAL FIELD

The present disclosure relates generally to the field of autonomous robot systems. In particular, this disclosure relates to analyzing performance of autonomous robotic mobile fulfilment systems.

### BACKGROUND

With the exponential growth of e-commerce companies, there has been an increase in demand for improved warehouse management. At a high-level, warehouse management includes determining a layout for a warehouse, scheduling labor, managing inventory, and fulfilling orders. In the recent times, warehouse management has become more challenging due to rising costs, labor shortages, increase in customer demand, and other supply chain issues. Some organizations have begun utilizing autonomous robotic mobile fulfilment systems to overcome these challenges.

Typically, autonomous robotic mobile fulfilment systems comprise autonomous guided vehicles that are configured to automate the tasks of storing and retrieving goods and materials within an environment (e.g., a warehouse). Such systems significantly increase the productivity and efficiency of the performance of the warehouses. However, existing autonomous robotic mobile fulfilment systems have several limitations. Firstly, existing systems are designed to fulfill single line orders (e.g., orders with multiple units of the same product). Secondly, the autonomous guided vehicles of existing systems are configured to transport entire shelves of orders (e.g., entire shelves of product(s)) between workstations and storage areas in the warehouse, thereby imposing significant limitations on the height and weight of the shelves.

Therefore, there is a demand for improved autonomous robotic mobile fulfilment systems that are designed to fulfill multiple line orders (e.g., orders with units of different products) without having to impose limitations on the height and weight of the shelf. To this end, there is also an unmet need to analyze the performance of these improved robotic mobile fulfilment systems in a fast and accurate manner.

### BRIEF DESCRIPTION OF THE DRAWINGS

FIG. 1 depicts an example representation of existing autonomous robot system(s) comprising autonomous guided vehicle(s) that are configured to transport shelves within an environment.

FIG. 2 shows an example of an improved autonomous guided vehicle that transports individual cases between various locations of the warehouse.

FIG. 3 provides an illustration of considerations to be made while designing improved autonomous robot system(s) that comprise autonomous guided vehicles configured to transport cases within a warehouse.

FIG. 4 provides a high-level illustration of the technology to analyze performance of improved autonomous robot system(s) as described herein.

FIG. 5 illustrates an example variation of a system for analyzing performance of improved autonomous robot system(s).

FIGS. 6A and 6B is a flowchart depicting an example simulation-based method that is implemented by the simulation module to determine the steady-state average travel durations of the autonomous guided vehicles.

FIG. 7 illustrates an example analytical model that is built by the analytical module to analyze the performance of improved autonomous robot system(s).

FIG. 8 illustrates an example network that is generated to solve the analytical model generated in FIG. 7.

FIG. 9 is a flowchart depicting an example method for analyzing performance of improved autonomous robot system(s).

FIG. 10 illustrates an example scenario of implementing an improved autonomous robot system(s) in an example warehouse.

FIGS. 11A and 11B depict a comparison of steady-state performance obtained from the technology described herein and discrete event simulation.

### DETAILED DESCRIPTION

Non-limiting examples of various aspects and variations of systems and methods for analyzing performance of autonomous robot system(s) are described herein and illustrated in the accompanying drawings.

As used herein, “autonomous robot system(s)” can comprise autonomous guided vehicles that are configured to automate tasks (e.g., store and/or retrieve goods and materials so as to fulfil orders) within an environment (e.g., warehouse). More specifically, “autonomous robot system(s)” described herein can include autonomous guided vehicles that fulfil orders within an environment given the specification of the environment (e.g., layout of the warehouse), and given the specification and/or configuration of resources within the environment (e.g., number of resources within the warehouse, operational time of resources within the warehouse, configuration of resources within the warehouse, etc.).

Accordingly, “performance of the autonomous robot system(s)” as used herein can refer to the performance of the autonomous guided vehicles and the performance of the environment (e.g., performance of resources within the environment) such that the automated tasks are completed (e.g., orders are fulfilled).

Systems and methods for estimating performance of an autonomous robot system that is configured to fulfil multiple line orders are described herein. The autonomous robot system comprises a plurality of autonomous guided vehicles configured to transport one or more cases within an environment so as to fulfil the multiple line orders. In some variations, a method includes obtaining first input data, generating a simulation model based at least in part on the first input data, determining a travel duration for each of the plurality of autonomous guided vehicles based on an execution of the simulation model, generating an analytical model based at least in part on the travel duration, and estimating the performance of the autonomous robot system based on an execution of the analytical model. The first input data includes data associated with operation of each of the plurality of autonomous guided vehicles and data representing a layout of the environment.

According to an embodiment there is provided a computer-implemented method of estimating performance of an autonomous robot system configured to fulfil multiple line orders. The autonomous robot system comprises a plurality of autonomous guided vehicles configured to transport one or more cases within an environment so as to fulfil the multiple line orders. The method comprises obtaining first input data via a user interface. The first input data includes data associated with operation of each of the plurality of autonomous guided vehicles and data representing a layout of the environment. The method further comprises generating, based at least in part on the first input data, a simulation model configured to simulate the operation of each of the plurality of autonomous guided vehicles within the environment. The method further comprises determining, based on an execution of the simulation model, a travel duration for each of the plurality of autonomous guided vehicles from a first location of one or more locations in the environment to a second location of the one or more locations in the environment. The method further comprises generating, based at least in part on the travel duration, an analytical model configured to analyze the performance of the autonomous robot system, and estimating, based on an execution of the analytical model, the performance of the autonomous robot system.

In some variations, estimating the performance of the autonomous robot system includes calculating a throughput time to fulfil the multiple line orders. Additionally or alternatively, estimating the performance of the autonomous robot system includes calculating a rate at which one or more resources in the environment are utilized to fulfil the multiple line orders.

In some variations, data associated with operation of each of the plurality of autonomous guided vehicles includes for each autonomous guided vehicle, at least one of: an order in which the one or more cases are to be retrieved by the autonomous guided vehicle from an order queue, an indication of how the many cases of the one or more cases are to be retrieved from the order queue in one trip, and a moving speed of the autonomous guided vehicle.

In some variations, determining the travel duration includes for each of the plurality of the autonomous guided vehicles determining at least one of: a first travel time from a current location of the autonomous guided vehicle to a location of the one or more cases, a second travel time from the location of the one or more cases to a location of a workstation, a third travel time from the location of the workstation to a storage location, and a fourth travel time from the storage location to a charging location. In some variations, determining the travel duration may further comprise: sampling the first travel time, the second travel time, the third travel time, and the fourth travel time for different type of multiple line orders; and determining an average travel time based on the sampling.

In some variations, the analytical model is a shared-token multi-class semi-open queuing network. Generating the analytical model may further comprise: representing a process of matching an autonomous guided vehicle of the plurality of autonomous guided vehicles to a first multiple line order as a first synchronization node, representing a process of retrieving the one or more cases by the autonomous guided vehicle as a second infinite service node, representing a process of traveling by the autonomous guided vehicle with the one or more retrieved cases to a workstation as a third infinite service node, representing a process of a picker at the workstation retrieving a product from the one or more cases as a fourth service node and representing a process of traveling by the autonomous guided vehicle from the workstation to a storage location as a fifth infinite service node.

In some variations, estimating the performance of the autonomous robot system comprises performing an approximated mean value analysis of the shared-token multi-class semi-open queuing network.

According to another embodiment there is provided a system for estimating performance of an autonomous robot system configured to fulfil multiple line orders. In some variations, the system comprises a user interface to obtain first input data and at least one controller communicably coupled to the user interface. The first input data includes data associated with operation of each of a plurality of autonomous guided vehicles and data representing a layout of an environment. The autonomous robot system comprises the plurality of autonomous guided vehicles configured to transport one or more cases within the environment so as to fulfil the multiple line orders. The controller is configured to: generate, based at least in part on the first input data, a simulation model configured to simulate the operation of each of the plurality of autonomous guided vehicles within the environment, determine, based on an execution of the simulation model, a travel duration for each of the plurality of autonomous guided vehicles from a first location of one or more locations in the environment to a second location of the one or more locations in the environment, generate, based at least in part on the travel duration, an analytical model configured to analyze the performance of the autonomous robot system, and estimate, based on an execution of the analytical model, the performance of the autonomous robot system.

In some variations, the controller is configured to calculate a throughput time to fulfil the multiple line orders to estimate the performance of the autonomous robot system. Additionally or alternatively, the controller is configured to calculate a rate at which one or more resources in the environment are utilized to fulfil the multiple line orders so as to estimate the performance of the autonomous robot system.

In some variations, data associated with operation of each of the plurality of autonomous guided vehicles includes for each autonomous guided vehicle, at least one of: an order in which the one or more cases are to be retrieved by the autonomous guided vehicle from an order queue, an indication of how the many cases of the one or more cases are to be retrieved from the order queue in one trip, and a moving speed of the autonomous guided vehicle.

In some variations, the controller may be configured to: for each of the plurality of the autonomous guided vehicles determine at least one of: a first travel time from a current location of the autonomous guided vehicle to a location of the one or more cases, a second travel time from the location of the one or more cases to a location of a workstation, a third travel time from the location of the workstation to a storage location, and a fourth travel time from the storage location to a charging location. The controller may be further configured to: sample the first travel time, the second travel time, the third travel time, and the fourth travel time for different type of multiple line orders, and determine an average travel time based on the sampling.

In some variations, the analytical model is a shared-token multi-class semi-open queuing network. The controller may be configured to: represent a process of matching an autonomous guided vehicle of the plurality of autonomous guided vehicles to a first multiple line order as a first synchronization node, represent a process of retrieving the one or more cases by the autonomous guided vehicle as a second infinite service node, represent a process of traveling by the autonomous guided vehicle with the one or more retrieved cases to a workstation as a third infinite service node, represent a process of a picker at the workstation retrieving a product from the one or more cases as a fourth service node, and represent a process of traveling by the autonomous guided vehicle from the workstation to a storage location as a fifth infinite service node, thereby generating the analytical model.

In some variations, the controller is further configured to perform an approximated mean value analysis of the shared-token multi-class semi-open queuing network so as to estimate the performance of the autonomous robot system.

Autonomous robot system(s) have become ubiquitous in the context of warehouse management, especially for handling goods and materials in warehouses. However, as discussed above, existing autonomous robot system(s) have several limitations. For instance, since existing autonomous robot system(s) comprise autonomous guided vehicles that are configured to transport entire shelves with products, there are limitations imposed on the height and weight of the shelves. This leads to reduced space utilization, which could be detrimental to the efficiency of the performance of the autonomous robot system(s). Furthermore, if an order requires multiple units of different products (referred to herein as “multiple line order”) to be fulfilled, then transporting entire shelves would result in the autonomous guided vehicles having to make several trips between various locations (e.g., processing stations, central storage, dynamic storages, charging stations, etc.) of the warehouse. This leads to elongated travel times and diminishes the efficiency of the autonomous robot system(s), thereby impacting the efficiency of the performance of the warehouse.

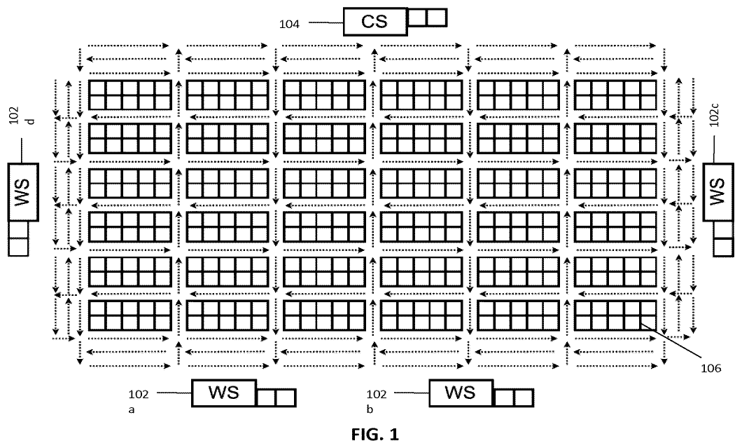

FIG. 1 depicts an example representation (e.g., 2D representation) of existing autonomous robot system(s) comprising autonomous guided vehicle(s) that are configured to transport shelves within an environment (e.g., warehouse). As seen in FIG. 1, autonomous guided vehicles are configured to transport shelves between workstations or processing stations, such as for example, 102a, 102b, 102c, and 102d (collectively referred to herein as workstation 102), central storage 104, and dynamic storages, such as for example dynamic storage 106 depicted FIG. 1.

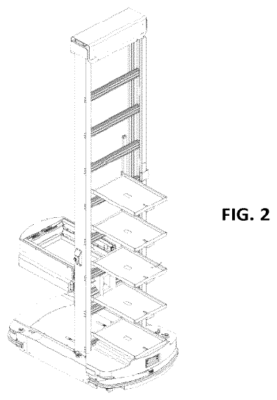

To overcome the challenges of existing autonomous robot system(s), autonomous robot system(s) comprising autonomous guided vehicles that transport individual cases from shelves between various locations (e.g., processing stations, central storage, dynamic storages, charging stations, etc.) of the warehouse are being developed. FIG. 2 shows an example autonomous guided vehicle that transports individual cases between various locations of the warehouse. Such autonomous guided vehicles are specifically efficient for fulfilling multiple line orders. In contrast to single line orders (e.g., orders requiring multiple units of a same product), multiple line orders are orders with different products that may need to be stored and retrieved together. For instance, multiple line products may be a group of products sold under different brand names which the customers can distinguish between. These orders may require varying units of different products. Improved autonomous robot system(s) comprising autonomous guided vehicles (e.g., autonomous guided vehicle depicted in FIG. 2) that transport individual cases within an environment (e.g., warehouse) can fulfill multiple line orders more efficiently than existing systems. As used herein, the term “improved autonomous robot system(s)” refers to autonomous robot system(s) that include autonomous guided vehicles, such as in FIG. 2, that are configured to transport cases as opposed to entire shelves given a specification of an environment (e.g., warehouse) and/or given a specification and/or configuration of resources within the environment such that orders are fulfilled. An autonomous guided vehicle that transport cases within the warehouse is also referred to as “robot” in this disclosure.

But, in developing such improved autonomous robot system(s) (e.g., comprising autonomous guided vehicles that transport individual cases in a warehouse), it is important to analyze the performance of these autonomous robot system(s). Such analysis can help determine the layout of the warehouse, the allocation of resources within the warehouse, the operational design of the autonomous guided vehicles, the design of the autonomous robot system(s), etc.

Existing technologies that analyze the performance of existing autonomous robot system(s) cannot be directly applied to these improved autonomous robot system(s) owing to various technical challenges. For example, some existing technologies use discrete event simulation to analyze the performance of autonomous robot system(s). But, discrete event simulation requires analyzing large number of sample data so as to extract the possibilities of various events to determine expected performance of the autonomous robot system(s). This makes discrete event simulation computationally inefficient.

More recently, technologies that implement queuing network are being used to analyze the performance of existing autonomous robot system(s). Although these technologies are more efficient (e.g., computationally efficient) than discrete event simulation, they still have technical challenges. Firstly, existing methodologies that implement queuing network assume that the average traveling time of the autonomous guided vehicles between various locations in the warehouse is the same. Furthermore, these existing methodologies assume that the time taken by the autonomous guided vehicles at workstations to process the orders (i.e., processing time at workstations) is the same. In reality, the average traveling time of the autonomous guided vehicles and the processing time at workstations is dependent on the order (e.g., number of lines within an order) that the autonomous guided vehicles are fulfilling. Therefore, such assumptions can impact the accuracy of the analysis.

Secondly, existing methodologies that implement queuing network assume that the number of lines within an order (e.g., number of products and/or items in a single order) follow a same probability density function. More specifically, existing methodologies assume that the probability density function of the number of lines within an order follow geometric distribution. In reality, the number of lines within an order can follow any suitable form of distribution. Therefore, this assumption can further impact the accuracy of the analysis.

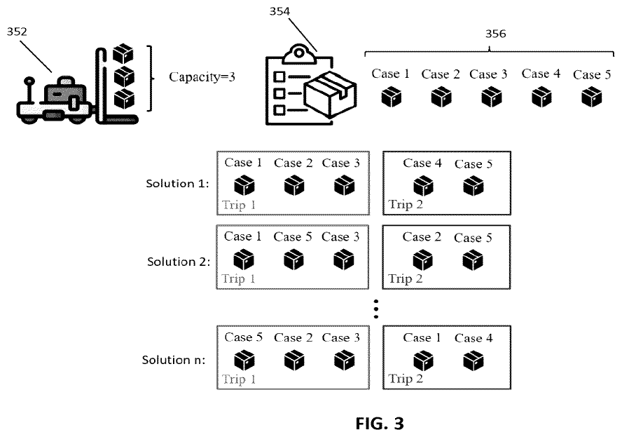

Thirdly, existing methodologies that implement queuing network are configured to simply calculate the average traveling time of the autonomous guided vehicles during the operational process (e.g., during the operation of the autonomous guided vehicles within an environment (e.g., warehouse)). Essentially, these existing methodologies are simply solving the common path problem for the autonomous robot system(s). In reality, when improved autonomous robot system(s) comprising autonomous guided vehicles that transport cases from shelves are deployed, apart from the common path problem, there are two additional problems to consider. FIG. 3 provides an illustration of considerations that are to be made while designing improved autonomous robot system(s) that comprise autonomous guided vehicles configured to transport cases within a warehouse. In FIG. 3, as an example, the capacity of the autonomous guided vehicle 352 is three cases. Put differently, the autonomous guided vehicle 352 can transport a maximum of three cases in one trip. However, the order 354 to be fulfilled, includes five cases (e.g., represented as 356 in FIG. 3). Therefore, the autonomous guided vehicle 352 has to make at least two trips to fulfill the order. Therefore, one consideration in such a situation is how to allocate the cases to different trips? This is referred to as the “allocation problem.” For instance, as seen in FIG. 3, one solution could be to allocate case 1, case 2, and case 3 to a first trip and case 4 and case 5 to a second trip. Similarly, another solution could be to allocate case 5, case 2, and case 3 to a first trip and case 1 and case 4 to a second trip. Another consideration in this situation is what the sequence for picking the cases within a trip should be? This is referred to as the “case retrieval problem.” For instance, if case 1 and case 4 are allocated to a second trip, then in one solution case 1 can be picked up first and case 4 can be picked up after case 1. Similarly, in another solution, case 4 can be picked up first and case 1 can be picked up after case 4. Given the above-identified problems to be considered, using existing methodologies to analyze the average traveling time of the autonomous guided vehicles can make the analysis difficult and time-consuming.

For the aforementioned reasons, existing methodologies are computationally inefficient and inaccurate to analyze the performance of improved autonomous robot system(s) comprising autonomous guided vehicles that store, retrieve, and transport cases within an environment (e.g., warehouse). Described herein are systems and methods for analyzing the performance of these improved autonomous robot system(s) in a computationally fast and accurate manner. The technology described herein utilizes a combination of simulation modeling and analytical modeling to analyze the performance of improved autonomous robot system(s). At a high-level, the technology described herein generates a simulation model to simulate the operation of autonomous guided vehicles. The travel duration of the autonomous guided vehicles to various locations within the warehouse can be determined based on the execution of the simulation model. The technology described herein generates an analytical model based at least in part on the determined travel duration. The analytical model is then analyzed so as to estimate and/or predict the performance of the improved autonomous robot system(s). Compared to the existing methodologies, the technology described herein can achieve about 90 percent accuracy when estimating the performance of the improved autonomous robot system(s). Furthermore, compared to the existing methodologies, the technology described herein is computationally faster (e.g., about 1000 times faster) when investigating the influence of the order arrival configuration (e.g., average rate at which the orders arrive, probability density function of orders with different number of lines, etc.) and the specification and availability of resources (e.g., location and availability of autonomous guided vehicles, charging station, picking station, etc.) on the performance of the improved autonomous robot system(s).

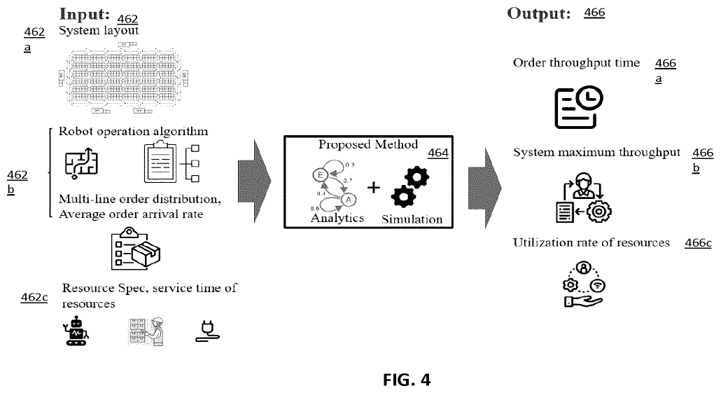

FIG. 4 provides a high-level illustration of the technology described herein to analyze the performance of improved autonomous robot system(s). As seen in FIG. 4, the systems and methods described herein obtains input 462. Input 462 includes data representing a layout of an environment (e.g., layout of a warehouse), such as for example, input 462a (i.e., system layout). Input 462 further includes data associated with operation of each autonomous guided vehicles, such as for example, input 462b (i.e., robot operation algorithm, multiple line order distribution, average order arrival rate). Input 462 also includes data associated with the resources in the warehouse (e.g., specification and configuration of resources), such as for example, input 462c (i.e., resource spec, service time of resources). The systems and methods described herein generates and executes a combined simulation and analytical model (e.g., model 464). The system and methods described herein then outputs the estimated performance of the autonomous robot system(s) based on the execution of model 464. The output 466 can include order throughput time 466a, maximum throughput of the autonomous robot system(s) 466b, and utilization of resources in the warehouse 466c.

### EXAMPLE SYSTEM

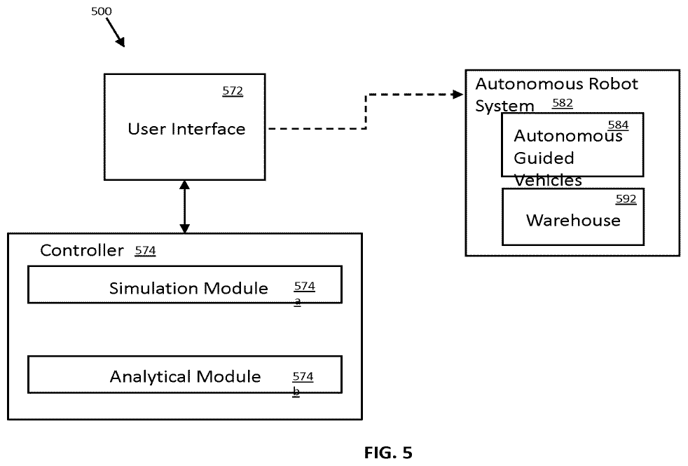

FIG. 5 illustrates an example variation of a system 500 for analyzing performance of improved autonomous robot system(s) 582. A high-level implementation of the system 500 is described with reference to FIG. 4 above. The system 500 includes a user interface 572 that is configured to obtain input (e.g., input 462 described in relation to FIG. 4) and transmit output (e.g., output 466 described in relation to FIG. 4). The user interface 572 is communicably coupled to a controller 574. In some variations, the output obtained from the user interface 572 may be utilized by the improved autonomous robot system(s) 582 to optimize the operation of autonomous guided vehicles 584. In a similar manner, in such variations, the output obtained by the user interface 572 may be utilized to optimize the layout and the configuration of resources within a warehouse 592.

The user interface 572 may enable a user and/or a computing device to input data associated with a layout of an environment (e.g., layout of a warehouse), operation of the autonomous guided vehicles, and the specification and configuration of resources in the environment (e.g., warehouse). More specifically, the user interface 572 may enable a user and/or a computing device to input data representing a layout of an environment, such as for example, a visual representation of a warehouse representing the charging stations, workstations, central storage, dynamic storage, etc. The input data can also include data associated with the operation of the autonomous guided vehicles, such as for example, the distribution of lines in the orders, the arrival rate of the orders, the order in which the cases are to be retrieved by the autonomous guided vehicle, an indication of how many cases are to be retrieved in one trip, the moving speed of the autonomous guided vehicles, etc. The input data can also include data associated with the specification and/or configuration of resources in an environment, such as for example, configuration of charging stations, service time of charging stations, location of pickers, service time of pickers, idle location of the autonomous guided vehicles, etc. The input may be in any suitable format (e.g., text, audio, images, videos, numbers, a combination thereof, and/or the like).

In some examples, the user interface 572 may be rendered on any suitable computing device. Some non-limiting examples of computing device include computers (e.g., desktops, personal computers, laptops, etc.), tablets and e-readers (e.g., Apple iPad®, Samsung Galaxy® Tab, Microsoft Surface®, Amazon Kindle®, etc.), mobile devices and smart phones (e.g., Apple iPhone®, Samsung Galaxy®, Google Pixel®, etc.), etc. The computing device may be communicatively coupled to a controller 574 via a network (e.g., Internet, Local Area Network (LAN), Wider Area Network (WAN), and/or the like).

In some variations, the controller 574 may include one or more servers and/or one or more processors running on a cloud platform (e.g., Microsoft Azure®, Amazon® web services, IBM® cloud computing, etc.). The server(s) and/or processor(s) may be any suitable processing device configured to run and/or execute a set of instructions or code, and may include one or more data processors, image processors, graphics processing units, digital signal processors, and/or central processing units. The server(s) and/or processor(s) may be, for example, a general purpose processor, a Field Programmable Gate Array (FPGA), an Application Specific Integrated Circuit (ASIC), and/or the like.

In some variations, controller 574 may include a processor (e.g., CPU). The processor may be any suitable processing device configured to run and/or execute a set of instructions or code, and may include one or more data processors, image processors, graphics processing units, physics processing units, digital signal processors, and/or central processing units. The processor may be, for example, a general purpose processor, a Field Programmable Gate Array (FPGA), an Application Specific Integrated Circuit (ASIC), and/or the like. The processor may be configured to run and/or execute application processes and/or other modules, processes and/or functions associated with the system and/or a network associated therewith. The underlying device technologies may be provided in a variety of component types (e.g., MOSFET technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, and/or the like.

In some examples, the controller 574 may be configured to analyze the performance of the improved autonomous robot system(s). For example, the controller 574 may be configured to implement one or more modules of the system 100. The one or more modules include simulation module 574a and analytical module 574b. The modules 574a and 57b may include instructions to perform one or more of the following: (1) generate a simulation model to simulate the operation of the autonomous guided vehicles of the improved autonomous robot system, (2) execute the simulation model, (3) determine travel durations for the autonomous guided vehicles, (4) generate an analytical model to analyze the performance of the improved autonomous robot system, and (5) analyze the analytical model to estimate the performance of the improved autonomous robot system.

The controller 574 (e.g., the processor of the controller) may include instructions and/or software code to execute the modules 574a and 574b. In some examples, the processor may execute both the modules. In some examples, the instructions and/or software code may include separate calls to separate modules. A call to a first module may redirect the processing performed by the controller 574 to implement instructions included in that first module. Following the execution of that first module, if the instructions and/or software code include a call to a second module, then the processing may be redirected to implement instructions included in the second module. In some examples, the controller 574 may execute each module 574a and 574b in a series one after another. Alternatively, the controller 574 may execute the two modules 574a and 574b simultaneously. In some examples, both the modules 574a and 574b may be combined into a single module. These modules 574a and 574b and their functions are described in detail below.

The output from the controller 574 is transmitted to the user interface 572. The output may be in any suitable format (e.g., text, audio, video, images, numbers, a combination thereof, etc.). The output can include performance metrics of the improved autonomous robot system(s) such as for example, throughput time of the improved autonomous robot system(s), maximum throughput of the improved autonomous robot system(s), utilization of resources in the environment (e.g., warehouse), etc. The output can be used to determine an optimized layout for a warehouse 592, design the improved autonomous robot system(s) 582, design the autonomous guided vehicles 584, determine an optimized configuration for the resources in the warehouse 592, determine an optimized specification for the resources in the warehouse 592, etc.

### Simulation Module

To analyze the performance of the improved autonomous robot system(s), the simulation module (e.g., structurally and/or functionally similar to simulation module 574a in FIG. 5) is configured to implement a simulation-based approach. In particular, the simulation module as described herein is configured to generate a simulation model and execute the simulation model so as to determine the steady-state average travel durations of the autonomous guided vehicles for all travel processes that are involved during the operation of the autonomous robot system(s). For example, the simulation module is configured to generate and execute the simulation model to determine the travel duration of the autonomous guided vehicle for retrieving cases in a specific order, moving cases to a designated workstation, moving cases to a previous storage location (e.g., moving empty cases from workstations to area from where cases were initially retrieved), moving to a battery charging station, and moving from the battery charging station to a dwell point.

The simulation model is generated and executed such that the steady-state average travel durations of the autonomous vehicles are not dependent on the allocation of resources within an environment (e.g., allocation of resources such as autonomous guided vehicles, pickers, charging stations, chargers, etc. in a warehouse). Instead, these steady-state average travel durations are dependent on: (1) case retrieval policy within a trip (e.g., a sequence in which cases are to be retrieved within a trip), (2) case allocation policy between trips (e.g., the number of cases to be allocated for each trip so as to fulfill an order), (3) path planning instructions that are generated for the autonomous guided vehicles, (4) moving speed of the autonomous guided vehicles, and (5) the layout of the environment (e.g., layout of the warehouse).

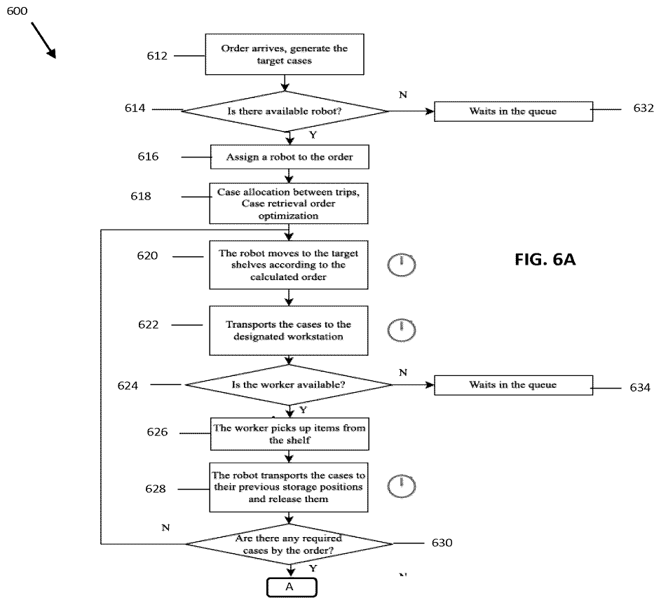

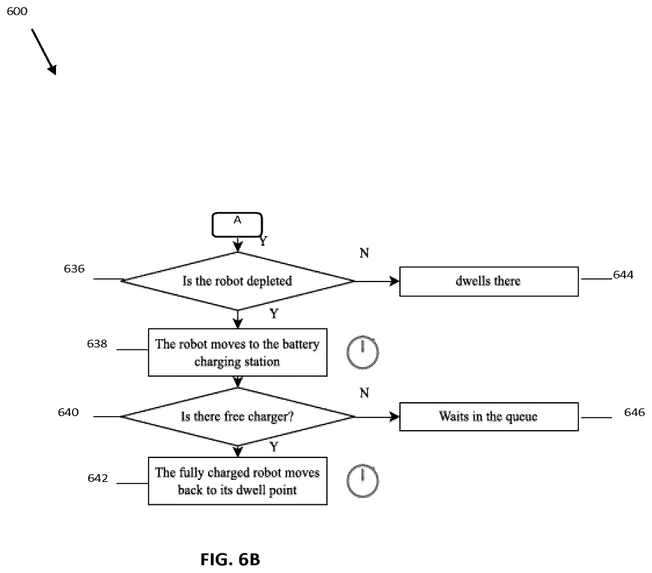

FIGS. 6A and 6B is a flowchart depicting an example simulation-based method that is implemented by the simulation module to determine the steady-state average travel durations of the autonomous guided vehicles. The simulation model is generated by the simulation module as depicted in FIGS. 6A and 6B. At 612, orders that are to be fulfilled arrive in the environment (e.g., arrive at the warehouse) and wait in an order queue. At 616, the simulation module randomly assigns an idle autonomous guided vehicle to the first waiting order.

An order might require multiple cases to be distributed to various locations of the environment (e.g., central storage area, dynamic storage area of a warehouse). As discussed above, the maximum number of cases an autonomous guided vehicle can carry within one trip may be limited (e.g., based on the capacity of the autonomous guided vehicles). Therefore, an order might require an autonomous guided vehicle to conduct several trips to complete it. At 618, an autonomous guided vehicle decides the order of case retrieval, then at 620, the autonomous guided vehicle moves from its current location to the targeted cases of this trip that are stored on the shelves according to a certain order. The order of case retrieval and/or the order in which the autonomous guided vehicle moves to the targeted cases may be optimized or random. Alternatively, the order of case retrieval may be decided centrally by the central system and communicated to the autonomous guided vehicle in question.

At 622, after the autonomous guided vehicle picks up all the cases that are to be transported in one trip from the shelf, it transports them to the designated workstation. The number of workers in the workstation can be limited. At 634, an autonomous guided vehicle enters the workstation buffer and waits for its turn.

At 626, once a picker retrieves the products from the cases, at 628, the autonomous guided vehicle returns the empty cases to their original storage places. The order for transporting the empty cases to their original storage location (referred to herein as “the case storage process”) could be either random or optimized. At 630, the autonomous guided vehicle checks whether there are remaining cases that are required so as to fulfill that order. If there are remaining cases, it goes back to step 620. If not, the order will be released.

At 636, the autonomous guided vehicle then checks whether the remaining battery is below a predefined threshold. If yes, the autonomous guided vehicle may have to get to a charging station. The number of autonomous guided vehicles a charging station can simultaneously serve may be limited. An autonomous guided vehicle may therefore, at 646, enter the workstation buffer and wait for its turn if the number of autonomous guided vehicles at the charging station exceeds a certain limit. After finishing charging, the autonomous guided vehicle returns to the shelf storage region. If the remaining battery level is above the threshold at 636, the autonomous guided vehicle becomes idle and waits for another order to be assigned to it (e.g., at 644).

After the simulation model has been generated, the simulation module executes the simulation model to sample travel durations of the autonomous guided vehicles. For example, travel durations at step 620, step 622, step 628, step 638, and step 642 are sampled for different types of orders and for different types of trips that fulfill the orders. The execution of the simulation model is terminated when the average of the travel durations for each of step 620, step 622, step 628, step 638, and step 642 that are collected from the samples converges. For example, the execution of the simulation model may be terminated when the confidence interval of the average of the travel durations for each of step 620, step 622, step 628, step 638, and step 642 fall below 1% of each of the respective average value. The converged travel durations are transmitted to the analytical module as input to the analytical module.

### Analytical Module

To analyze the performance of the improved autonomous robot system(s), the analytical module (e.g., structurally and/or functionally similar to analytical module 574b in FIG. 5) is configured to implement an analytical-based approach. In particular, the analytical module as described herein is configured to analyze the influence of the distribution of the multiple line order, the order arrival configuration, the specification and availability of resources, the service-time of resources, etc. on the performance of the improved autonomous robot system(s). More specifically, the average travel duration is determined by the simulation module. The analytical module uses this average travel duration that is determined by the simulation module to analytically determine the influence of the number of resources in an environment (e.g., robots, pickers, and chargers), average order arrival rate, multiple line order distribution, and service time distribution at workstations and changing stations on the performance of the improved autonomous robot system(s). As described in detail below, the analytical module constructs a shared-token multi-class semi-open queuing network (SOQN) to analyze the influence of the above-mentioned processes on the performance of the improved autonomous robot system(s). In some variations, the analytical module applies approximated mean value analysis to solve the SOQN.

### Assumptions to Generate the Analytical Model

In order to generate the analytical model, the analytical module makes the following assumptions:

(1) The order arrival follows a Poisson distribution. The average order arrival rate is defined as λ. Arriving orders are served by the autonomous guided vehicles on a first-come-first-serve basis. There might be multiple lines in the order. Orders are classified into different classes based on the number of lines in the order. Assume the number of lines within the order varies from 1 to Nₗ. Then there should be Nₗ different class orders. In this disclosure, O={1, . . . . Nₗ} is used to denote the set of indices for Nₗ order classes. For each r ∈ O, the probability of an arrival order belonging to r class is defined as p (r), the average order arrival rate is denoted as λᵣ, the number of lines within the order is defined as Nᵣ, the number of trips needed to fulfil the order is defined as NT_{γ}. In this disclosure, Tᵣ={1, . . . . NTᵣ} is used to denote a set of indices for NTᵣ trips while fulfilling the class r order.

(2) Assume there are N_{w}, workstations in the environment (e.g., in the warehouse). The set of indices for N_{w} workstations could be denoted as W={1, . . . . N_{w}}.

After the picker retrieves the products from the case the autonomous guided vehicle takes the cases (e.g., empty cases) from the workstation to the storage area (e.g., original storage area). Once the autonomous guided vehicle has stored the cases back in their original storage locations (i.e., the location from where the cases were initially retrieved), it waits at the final point of the storage process. Instead of stopping at a predetermined dwell point, the autonomous guided vehicle follows the point of service completion (POSC) dwell point policy. Put differently, once the autonomous guided vehicle has stored the cases back in their original storage location, instead of moving to a predetermined dwell point to wait for the next order, the autonomous guided vehicle waits at its final location until it is matched with a new/next order.

The same autonomous guided vehicle will complete the order. However, there is a maximum limit to the number of cases the autonomous guided vehicle can carry simultaneously. Therefore, if the number of cases in an order exceeds the autonomous guided vehicle's capacity, several trips may have to be made to fulfill the order. These trips would involve case retrieval process (e.g., process of retrieving cases from the original storage location), workstation processing (e.g., processing the cases at workstations such as for example, the process of pickers retrieving products from the cases), and the case storage process (e.g., the process of storing empty cases back at the original storage location).

The average processing time and coefficient of variance for one case at a workstation are denoted as u_{wi} and cv_{wi} respectively.

### Generating the Analytical Model

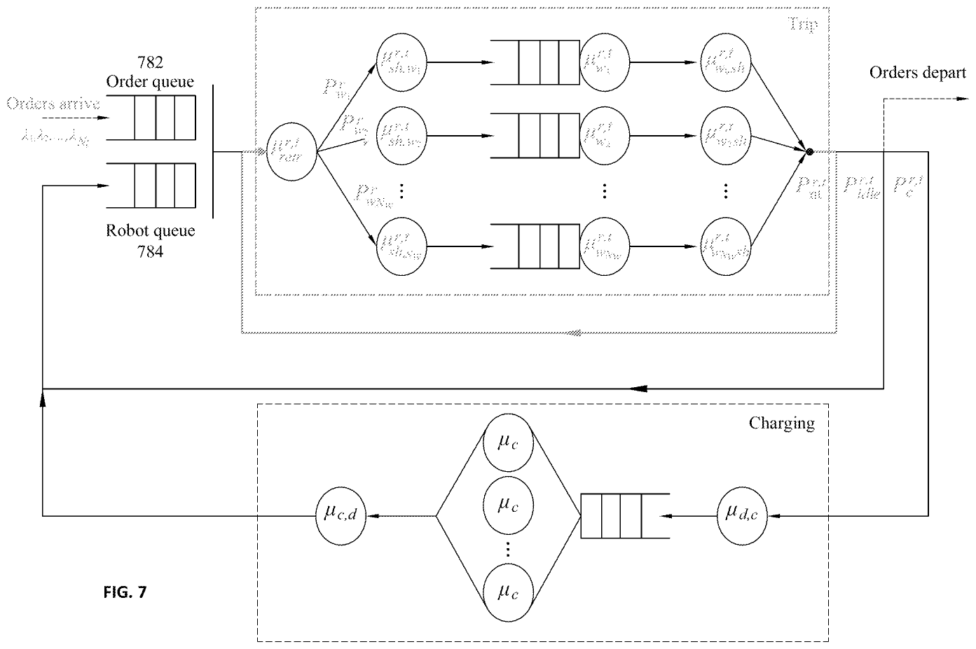

FIG. 7 illustrates an example analytical model that is built by the analytical module as described herein. The analytical model is used to analyze the performance of improved autonomous robot system(s). In some variations, the analytical model is a shared-token multi-class semi-open queuing network (SOQN). Put differently, the autonomous guided vehicles are constructed as a shared-token. Furthermore, the autonomous guided vehicles are modeled as multiple types of customers in the queuing network that differ from each other in the order lines that they fulfil, thereby resulting in the construction of a multi-class queuing network. Additionally, the orders are also modeled as customers in the queuing network. However, the orders are assumed to leave the queuing network once the orders are completed which the autonomous guided vehicles (also modeled as customers) are assumed to not leave the queuing network, thereby resulting in the construction of a semi-open queuing network.

The analytical model (e.g., shared-token multi-class SOQN) can be generated by representing one or more operational processes of the improved autonomous robot system(s) as a respective node. Some example nodes include synchronization node, infinite service node, and service node. A “service node” is considered to include servers that are resources configured to process or serve customers. In some variations of generating the analytical model, it is assumed that a server can deal with one customer at a time. Accordingly, it is assumed that the capacity of a service node is defined by the number of servers that are available to process or serve the customers. An “infinite service node” is a service node that has infinite number of servers.

In some variations, generating the analytical model includes representing each of the traveling processes such as for example, a process of retrieving the one or more cases by the autonomous guided vehicles, a process of traveling by the autonomous guided vehicles with the one or more retrieved cases to a workstation, and a process of traveling by the autonomous guided vehicles from the workstation to a storage location (e.g., from where the original location from where the cases were retrieved) as a respective infinite service node. This is because no matter how many autonomous guided vehicles (e.g., customers) arrive at the respective infinite service node at the same time, each of them can travel immediately as if there are infinite servers providing service to the customers (i.e., autonomous guided vehicles) within the service node. Furthermore, generating the analytical model includes representing a process of a picker at the workstation retrieving a product from the one or more cases as a service node.

Additionally or alternatively, generating the analytical model includes representing a process of matching an autonomous guided vehicle to a multiple line order as a synchronization node. As discussed above, the queuing network is constructed with both the autonomous guided vehicles and the orders are customers. The synchronization node is constructed to include two queues. Each of the two queues in the synchronization node are considered as both server and customer for each other.

The generated analytical model is described below:

As seen in FIG. 7, in this example analytical model, there are N autonomous guided vehicles in the improved autonomous robot system(s). When an order arrives to the system, it waits in the order queue 782 and is then matched with an available autonomous guided vehicle. The autonomous guided vehicle acts as a shared token, which can provide service to different multiple line orders. The matching process is modelled as a synchronization station (also referred to as “synchronization node”), where there are two queues: order queue 782 and available autonomous guided vehicle queue 784, and at least one of the two queues is empty. As discussed above, the queuing network is constructed with both the autonomous guided vehicles and the orders are customers. Accordingly, the synchronization node includes two queues (i.e., order queue 782 and available autonomous guided vehicle queue 784). Each of the two queues in the synchronization node are considered as both server and customer for each other.

In this analytical model, for each r ∈ O and t ∈ Tᵣ, the autonomous guided vehicle picks the required cases by the t trip from shelves in a certain order which could be random or optimized while fulfilling the class r order. The case retrieval process (e.g., the process of allocating a sequence in which the cases are to be retrieved in a trip and the process of retrieving the cases according to this sequence) is modelled as an infinite service node (IS) (e.g., as a node comprising infinite servers), because once the autonomous guided vehicle and the order match, the autonomous guided vehicle can travel immediately without waiting. The average travelling time during this case retrieval process depends on the type of order r and the current trip t, the average travelling time of this node is

$$\frac{1}{{u}_{retr}^{r , t}} .$$

The autonomous guided vehicle travels from the last visited shelf of the retrieval process to the designated processing station (e.g., designated workstation). For each r ∈ O, wᵢ ∈ W, the probability for an order of class r to select workstation wt is denoted as p_{w}_{ᵢ}^{r}. With N_{w} workstations in the environment (e.g., warehouse), this travelling process is modelled as N_{w} infinite service nodes. The average time needed to travel from shelf storage area to workstation wᵢ is denoted as

$$\frac{1}{{u}_{sh , {w}_{i}}} .$$

After the autonomous guided vehicle reaches the workstation wᵢ, it joins the waiting queue and waits for its turn, then the picker retrieves the required products from the cases. If there is only one picker in every workstation, the process is modelled as N_{w} service nodes (e.g., node comprising finite number of servers) with a single server in every node. For each r ∈ O and t ∈ Tᵣ, the average process time

$$\frac{1}{{u}_{{w}_{i}}^{r , t}}$$

for a autonomous guided vehicle also depends on the type of order r and the current trip t.

After the service of the process station ends, the autonomous guided vehicle has to store all the picked cases back to its original position in a certain order which can be random or optimized. This travelling process is also modelled as N_{w} infinite service nodes. For each r ∈ R, t ∈ Tᵣ, wᵢ ∈ W, the average travelling time during this process is defined as

$$\frac{1}{{u}_{{w}_{i} , sh}^{r , t}} .$$

After case storage process, with probability Pₙₜ^{r,t}, the autonomous guided vehicle may have to continue to proceed to next trip after t trip, beginning from case retrieval process. With probability P_{idle}^{r,t}, after t trip, the autonomous guided vehicle will become idle and go to the autonomous guided vehicle queue 784 in the synchronization node, and the order will leave the autonomous robot system (i.e., the warehouse has fulfilled the order). With probability P_{c}^{r,t}, the autonomous guided vehicle has to go charging after t trip. All these possibilities depend on the autonomous guided vehicle's current serving order and trip.

If the autonomous guided vehicle goes to charge, the autonomous guided vehicle will go from its dwell point to charging station. This process is also modelled as an infinite service node, with average travelling time

$$\frac{1}{{u}_{d , c}} .$$

After the autonomous guided vehicle reaches the charging station, it joins the waiting queue and waits for its turn to charge. If an assumption is made that there is only one charging station, then the process can be modelled as a service node with N_{c} servers. The average charging time for a single autonomous guided vehicle is

$$\frac{1}{{u}_{c}} .$$

After finish charging, the autonomous guided vehicle will get back to its dwell point, which is modelled as an infinite service node, with average travelling time set to

$$\frac{1}{{u}_{c , d}} .$$

Then the autonomous guided vehicle becomes idle and enters the autonomous guided vehicle queue 784 of the synchronization node.

### Analysis of Operation of the Autonomous Guided Vehicles Using the Analytical Model

The characteristics of each service node in the example analytical model described in relation to FIG. 7 (i.e., the a shared-token multi-class semi-open queuing network described above) are analyzed as follows:

If it is assumed that the autonomous guided vehicles can carry as many cases required by the order as possible in every trip. For each r ∈ O, the number of trips (NTᵣ) that may be needed to fulfill the order r can be defined as:

$${NT}_{r} = ⌈ \frac{{N}_{r}}{C} ⌉ , \qquad ( 1 )$$

where Nᵣ is the number of lines in the r type of order, C is the capacity of the case handling autonomous guided vehicle, [•] is a round up function. For each r ∈ O, t ∈ Tᵣ, the number of cases required for r type of order in trip t can be defined as NC_{r,t}, which could be calculated as equation (2):

$${NC}_{r , t} = \{ \begin{matrix}C , & if t < {NT}_{r} \\ {N}_{r} - ( t - 1 ) C , & if t = {NT}_{r}\end{matrix} . \qquad ( 2 )$$

For each r ∈ O, t ∈ Tᵣ, the probability Pₙₜ^{r,t} for continuing next trip after finishing t trip could be defined as:

$${P}_{n t}^{r , t} = \{ \begin{matrix}1 , & if t < {T}_{r} \\ 0 , & if t = {T}_{r}\end{matrix} . \qquad ( 3 )$$

The average traveling time, including

$$\frac{1}{{u}_{retr}^{r , t}} , \frac{1}{{u}_{sh , {w}_{i}}} , \frac{1}{{u}_{{w}_{i} , sh}^{r , t}} , \frac{1}{{u}_{d , c}} , \frac{1}{{u}_{c , d}} ,$$

can be calculated from samples obtained from the simulation module.

To compute the probability for an autonomous guided vehicle carrying r type of order to go charging after completing t trip (P_{c}^{r,t}), the average traveling time for the autonomous guided vehicle to execute r type of order in the t trip ATT_{r,t} is to be calculated, which is:

$${ARR}_{r , t} = \frac{1}{{u}_{retr}^{r , t}} + {\sum }_{{w}_{i} = 1}^{{N}_{w}} {P}_{{w}_{i}}^{r} ( \frac{1}{{u}_{sh , {w}_{i}}} + \frac{1}{{u}_{{w}_{i} , sh}^{r , t}} ) . \qquad ( 4 )$$

It is assumed that the battery consumption is linearly related to the traveling time. The average battery consumption for an autonomous guided vehicle to fulfil an order is the average energy consumed while fulfilling different order types in varying trips:

$$DB = {\sum }_{r = 1}^{{N}_{l}} p ( r ) {\sum }_{t = 1}^{{NT}_{r}} dr \cdot {ATT}_{r , t} . \qquad ( 5 )$$

where dr denotes the percentage of battery depletion rate while moving.

The probability for an autonomous guided vehicle carrying r type of order to go charging after completing t trip (P_{c}^{r,t}) is shown in:

$${P}_{c}^{r , t} = \{ \begin{matrix}\frac{DBT}{100 - {th}_{c}} , & if t = {T}_{r} \\ 0 , & otherrwise\end{matrix} . \qquad ( 6 )$$

It is the reciprocal of the average number of orders that a fully charged battery can support before reaching the predefined battery threshold (th_{c}). If the autonomous guided vehicle still has remaining trips to complete an order, the P_{c}^{r,t} would be set to 0.

For r ∈ O, t ∈ Tᵣ, the probability for an autonomous guided vehicle to become idle and go to the autonomous guided vehicle queue 784 in the synchronization node when executing r type of order after finishing trip t is:

$${P}_{idle}^{r , t} = 1 - {P}_{c}^{r , t} - {p}_{n t}^{r , t} . \qquad ( 7 )$$

As for the average service time u_{w}_{ᵢ}^{r,t} and the coefficient of variance cv_{w}_{ᵢ}^{r,t} at the workstation wᵢ for r type of order at t trip, it can be calculated based on an input parameter (e.g., average service rate, and coefficient of variance for the picker to pick an item from the case), which is shown in equations (8) and (9) below:

$${u}_{{w}_{i}}^{r , t} = {u}_{{w}_{i}} {NC}_{r , t} \qquad ( 8 )$$

$${cv}_{{w}_{i}}^{r , t} = {cv}_{{w}_{i}} \qquad ( 9 )$$

### Analyzing Performance of the Autonomous Robot System Based on the Analytical Model

The performance of the autonomous robot system(s) can be analyzed based on the execution of the analytical model. In some variations, an analysis method such as for example, approximated mean value analysis (AMVA) may be performed on the analytical model so as to estimate the performance of the autonomous robot system(s). More specifically, the AMVA may be implemented to solve the shared-oken multi-class semi-open queuing network described above.

Given that based on the approach described herein, the process time at workstation and charging station obeys a general distribution, the queueing network described above may be considered as belonging to non-product form queueing network. There is no exact solution to such a queuing method. Accordingly, the shared-token multi-class queueing network generated above can be solved using single chain multiclass approximated mean value analysis (AMVA).

Prior to implementing AMVA, for each r ∈ O, the normalized mean number of visits (also known as the visit ratio) of an autonomous guided vehicle which execute class r type of order to every service node is to be calculated. If the visit ratio for the SOQN is chosen to be normalized such that:

$${V}_{sync} = {\sum }_{r = 1}^{{N}_{l}} {V}_{sync}^{r} = 1 , \qquad ( 10 )$$

where V_{sync} denotes the visit ratio of an autonomous guided vehicle to the synchronization node, V_{sync}^{r} denotes the visit ration of an autonomous guided vehicle executing class r type of order to the synchronization node. The probability of the r type of order for conducting trip t is calculated as:

$${P}_{r , t} = p ( r ) {\prod }_{i = 1}^{t} {P}_{n t}^{r , i} . \qquad ( 11 )$$

Since in every trip, autonomous guided vehicle will experience retrieval process, thus the visit ratio of an autonomous guided vehicle which are executing class r type of order to the retrieval node (Vᵣₑₜᵣ^{r,t}) is equal to P_{r,t}. As for other nodes within the trip, the visit ratio is calculated based on equation (12). As for the subprocesses within the charging procedure, the visit ratio of every involved charging node can be calculated as equation (13).

$${V}_{sh , {w}_{i}}^{r , t} = {V}_{{w}_{i}}^{r , t} = {V}_{{w}_{i} , sh}^{r , t} = {P}_{r , t} {P}_{{w}_{i}}^{r} \qquad ( 12 )$$

$${V}_{c} = {V}_{c , d} = {V}_{d , c} = {\sum }_{r = 1}^{{N}_{l}} {\sum }_{t = 1}^{{NT}_{r}} {V}_{t}^{r} {P}_{c}^{r , t} \qquad ( 13 )$$

In some variations, AMVA can be used to solve a SOQN using the following three steps:

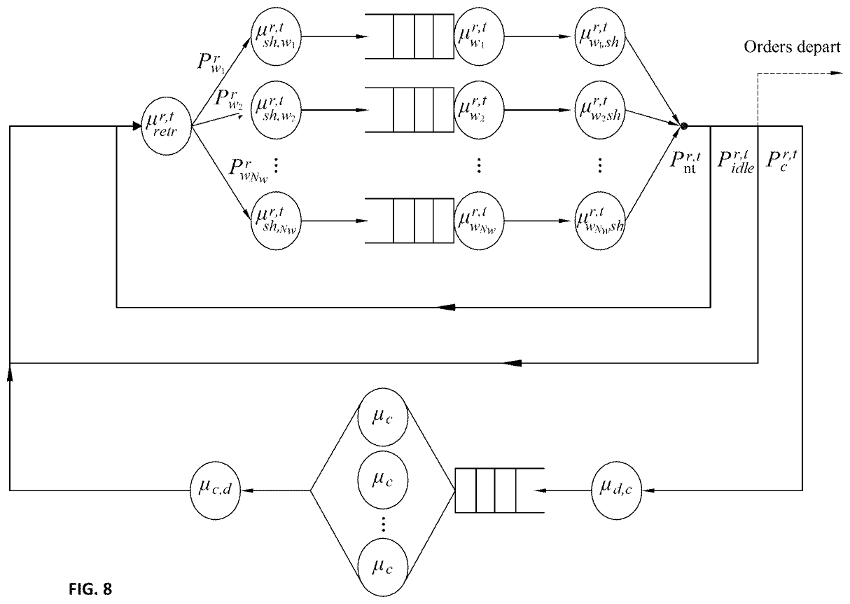

Step1: A Closed Queueing Network (CQN) is created by removing the synchronization station from the SOQN (e.g., the SOQN shown in FIG. 7). This is depicted in FIG. 8. This CQN can be analyzed with the single chain multiclass AMVA. The AMVA yields TH₁ which is the throughput of the CQN with N number of robots.

Step2: A second CQN is created by replacing the synchronization node in the SOQN with a load-dependent service node. This service node is denoted as node S+1, assuming there are S nodes in the first CON. Node S+1 has service rate u (n)=λ for n>1, where n robots are at the station. The network is only stable if λ<TH₁. For n=1, the service rate is

$$u ( 1 ) = ( 1 - \frac{λ}{T {H}_{1}} ) λ .$$

The same AMVA methodology can then be used to analyze this second CQN. The output of the AMVA methodology includes the expect waiting time WT_{w}_{ᵢ} at different workstation wᵢ, WT_{c} at charging station, the expected number of automated guided vehicles at automated guided vehicle queue 784 in the synchronization node denoted as N_{sync}, the probability of n automated guided vehicles at workstation wᵢ is P_{w}_{ᵢ} (n), the probability of n automated guided vehicles at charging station P_{c} (n).

Step3: The solution procedure analyzes synchronization node in isolation to calculate Lₒ which denotes the mean length of orders in the order queue of the synchronization node.

To estimate the performance of the autonomous robot system(s), step 4 may be implemented.

Step4: Compute the order throughput time, utilization rate of resources based on results got from Step2 and Step 3.

The utilization of the autonomous guided vehicles (ρᵣ) calculates the percentage of busy autonomous guided vehicles which are not available for being assigned an order. This can be calculated as equation (14).

$${ρ}_{r} = \frac{{N}_{sync}}{N} * 100 \qquad ( 14 )$$

The utilization of workstation (ρ_{w}_{ᵢ}) calculates the percentage of time when there is one or more autonomous guided vehicles in the workstation. This can be calculated as equation (15).

$${ρ}_{{w}_{i}} = ( 1 - {P}_{{w}_{i}} ( 0 ) ) \cdot 100 \qquad ( 15 )$$

Since there are N_{c} chargers in the charging station, the utilization rate of chargers in the charging station can be calculated as equation (16).

$${ρ}_{c} = ( 1 - {\sum }_{n = 0}^{{N}_{c} - 1} \frac{{N}_{c} - n}{{N}_{c}} {P}_{c} ( n ) ) \cdot 100 \qquad ( 16 )$$

The order throughput time THTᵣ calculates the duration from when r type of order arrive to when r type of order leave. It takes the external order waiting time, the average autonomous guided vehicle traveling time for retrieval and storage process, service time at different workstations, waiting time at different workstations into account. This can be calculated as equation (17). The overall order throughput can be calculated as equation (18).

$${THT}_{r} = \frac{{L}_{o}}{λ} + {\sum }_{t = 1}^{{T}_{r}} ( \frac{1}{{u}_{retr}^{r , t}} + {\sum }_{{w}_{i} = 1}^{{N}_{w}} {P}_{{w}_{i}}^{r} ( \frac{1}{{u}_{sh , {w}_{i}}^{r , t}} + {WT}_{{w}_{i}} + \frac{1}{{u}_{{w}_{i}}^{r , t}} + \frac{1}{{u}_{{w}_{i} , sh}^{r , t}} ) ) \qquad ( 17 )$$

$$THT = {\sum }_{r = 1}^{{N}_{l}} p ( r ) {THT}_{r} \qquad ( 18 )$$

In this manner, the performance of the improved autonomous robot system(s) can be calculated in a computationally fast and accurate manner.

### Example Method

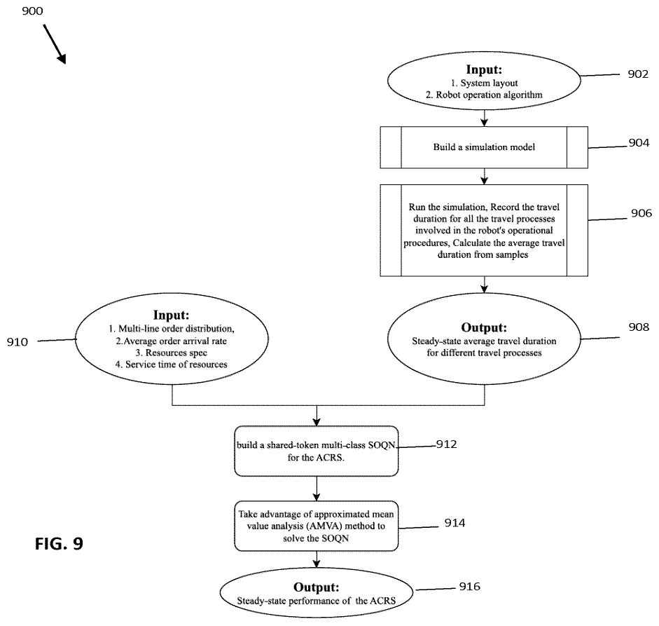

FIG. 9 is a flowchart depicting an example method 900 for analyzing performance of improved autonomous robot system(s). At step 902, the method 900 includes obtaining via a user interface (e.g., structurally and/or functionally similar to user interface 572 in FIG. 5) first input data. The first input data can include data associated with operation of the autonomous guided vehicles (e.g., case retrieval policy, case allocation policy, path planning instructions, and/or the like) and data representing a layout of the environment. For example, the first input data can include (1) case retrieval policy within a trip (e.g., sequence in which cases are to be retrieved within a trip), (2) case allocation policy between trips (e.g., the number of cases to be allocated for each trip so as to fulfill an order), (3) path planning instructions that are generated for the autonomous guided vehicles, (4) moving speed of the autonomous guided vehicles, and (5) the layout of the environment (e.g., layout of the warehouse).

At 904, the method includes generating a simulation model, via a controller (e.g., structurally and/or functionally similar to controller 574 in FIG. 5). In some variations, the simulation model may be generated via a module such as for example, simulation module 574a described herein. More specifically, the method 900 may implement the method described in FIGS. 6A and 6B to generate the simulation model.

At 906, the method 900 includes determining travel durations for the autonomous guided vehicles based on the execution of the simulation model generated at 904. For example, the method 900 may include determining the travel duration of the autonomous guided vehicles to move to targeted shelves to retrieve cases in a calculated order, determining the travel duration of the autonomous guided vehicles to transport the retrieved cases to designated workstations, determining the travel duration of the autonomous guided vehicles to transport empty cases from the workstations to the original storage locations, determining the travel duration of the autonomous guided vehicles to move to a charging station, and/or determining the travel duration of the autonomous guided vehicles to move from the charging station to its dwell point (e.g., original case retrieval area). In some variations, travel durations for different types of orders and for different types of trips that fulfill the orders are sampled to determine an average travel duration. In some variations, the execution of the simulation model is terminated when the average travel duration of the different samples converge.

At 908, the method outputs the results obtained from executing the simulation model. The output from the simulation model (e.g., steady-state average travel duration for different processes) is provided as an input to an analytical model (e.g., at step 908). At 912, the method includes generating an analytical model, via a controller (e.g., structurally and/or functionally similar to controller 574 in FIG. 5). In some variations, the analytical model may be generated via a module such as for example, analytical module 574b described herein.

In some variations, the analytical model may be a shared-token multi-class semi-open queuing network (SOQN). In a shared-token multi-class semi-open queuing network (SOQN), the autonomous guided vehicle act as a shared token which can provide service to different types of order. An order can be served if it matches with an idle case-handling autonomous guided vehicle. The matching process is considered as the synchronization node for the SOQN. Both autonomous guided vehicle and orders might wait for each other. Accordingly, there can be two queues, autonomous guided vehicle queue and order queue in this node.

After an autonomous guided vehicle is assigned to a type of order, the autonomous guided vehicle retrieves the cases required by the trip from shelves. The case retrieval process is modelled as an infinite service node (IS), because once the autonomous guided vehicle and the order match, the autonomous guided vehicle can travel immediately without waiting. As discussed above, the average travelling time has been calculated by the simulation model.

The autonomous guided vehicle travels from the last visited shelf of the retrieval process to the designated processing station. This process is modelled using infinite service nodes, the number of which is equal to the number of workstations in the environment (e.g., warehouse). The probability for a type of order to select a workstation is assumed to be input. As discussed above, the average travelling time has been calculated by the simulation model.

The process in the workstation is modelled using service nodes with a limited number of servers (e.g., pickers). The number of service nodes corresponds to the number of workstations, and the number of servers within each node is equivalent to the number of pickers in the workstation. The average and the number of cases carried within the trip can be determined. The average time and coefficient of variance required for a picker to retrieve a product from the case can be provided. Alternatively, the time distribution for a picker to pick a product from the case can be provided.

The case storage process is modelled using infinite service nodes, the number of which is equal to the number of workstations in the warehouse. As discussed above, the average travelling time has been calculated by the simulation model.

After the case storage process, the autonomous guided vehicles have three possible action branches: Continuing to proceed to the next trip beginning from the matching process; Becoming idle and joining the autonomous guided vehicle queue at the synchronization node; Going for charging. The probabilities of these branches can be calculated based on factors such as the order type, current trip information, battery depletion ratio per meter, and battery charging threshold.

If the autonomous guided vehicle goes to charge, the autonomous guided vehicle will go from its dwell point to charging station. This process is modelled as an infinite service node. As discussed above, the average travelling time has been calculated by the simulation model.

The service in the charging station is modelled as a service node with limited servers, the number of which is equal to the number of chargers. The average time and coefficient of variance required to charge an autonomous guided vehicle can be input. Alternatively, the charging time distribution can be provided.

After fully charged, the autonomous guided vehicle goes back to the shelf storage area (e.g., case retrieval area). Then it becomes idle and enter the autonomous guided vehicle queue of the synchronization node. As discussed above, the average travelling time has been calculated by the simulation model.

At 914, the method includes estimating the performance of the autonomous robot system(s) based on the execution of the analytical model generated at step 912. In some variations, estimating the performance of the autonomous robot system(s) may include performing approximated mean value analysis methodology on the generated analytical model. For example, the method may include calculating the visit ratio of each service node for different types of orders and various trips required to fulfill those orders. The method may further include removing the synchronization node, constructing a closed queueing network (CON) for the remaining nodes. The method may also include take advantage of Approximated Mean Value Analysis (AMVA) method to calculate the throughput of this CON. For example, this may include replacing the synchronization node with a load-dependent service node based on the throughput calculated by taking advantage of AVMA method on the CON. The service rate of this load-dependent service node depends on the number of autonomous guided vehicles in this node. Then the method may include constructing a second closed queuing network (CON2) for the load dependent service node plus complementary nodes. The method may include using AMVA to solve the CON2 and calculating the utilization of resources (autonomous guided vehicles, process stations, charging stations).

In this manner, the performance of the autonomous robot system(s) can be analyzed in a computationally fast and accurate manner.

Accordingly, as described above the method 900 implements a simulation-based approach to compute the steady-state average travel duration for all the travel processes that are involved in the operation of the autonomous robot system(s). In FIGS. 6A and 6B, there is a clock symbol near the travel processes that are determined using the simulation-based approach. The average values do not vary with the resource allocation (autonomous guided vehicles, pickers, chargers) in the environment (e.g., warehouse) and the order arrival rate. Instead, they depend on several factors: (1) the case retrieval policy within a trip, (2) the case allocation policy between trips, (3) the planned path for the autonomous guided vehicles, (4) autonomous guided vehicle's characteristics like moving speed (5) and the warehouse layout. Therefore, if these factors remain unchanged, there is no need to repeatedly calculate the steady-state average travel duration.

In summary, the technology described herein estimates the performance of autonomous robot system(s) by:

Generating a simulation model based on the operational processes of the automated robot system(s) and layout of the warehouse. Within the simulation, for each r ∈ O and t ∈ Tᵣ, the travel durations for different travel processes are recorded, as indicated by a clock symbol in FIGS. 6A and 6B. The simulation is terminated when the average of the collected samples converge.

Based on the operation of the automated robot system(s), the following elements are considered: (1) average travel durations calculated in previous steps; (2) the number of resources (autonomous guided vehicles, pickers, and chargers); (3) average order arrival rate and multiple line order distribution; (4) the service time distribution at workstations and charging stations.

With these components, a shared-token multi-class Service-Oriented Queueing Network (SOQN) is constructed for the automated robot system(s) in the warehouse. Approximated mean value analysis (AMVA) methodology is implemented to solve the SOQN model.

### Examples

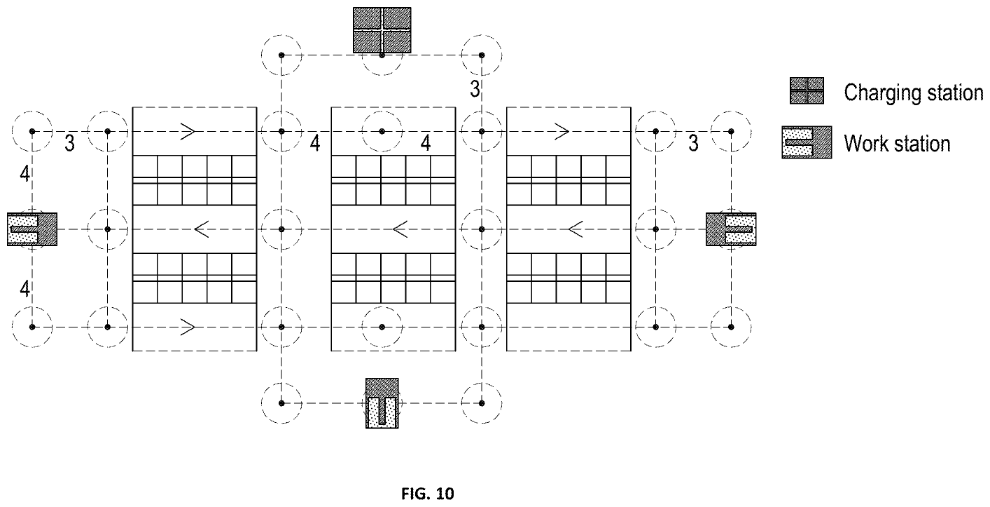

The accuracy of the estimation using the technology described herein is validated using discrete even simulation. The proposed SOQN solution is tested on the application scenario depicted in FIG. 10. In this example, the warehouse has 60 shelves. There are three workstations distributed in the warehouse. The time for a picker to retrieve a product from a case follows a uniform distribution, U [20,25] seconds. There is a charging station located at the top of the warehouse. The charging time for a single autonomous guided vehicle conforms to a uniform distribution, U [25, 35] minutes. The battery charging threshold th_{c} is set to 20%. The autonomous guided vehicle's speed is set to 0.5 m/s. The maximum capacity of autonomous guided vehicles is set to 5. The maximum number of lines in an order is set to 6. The probabilities for orders with 1 to 6 lines are set to [0.1, 0.2,0.2, 0.1,0.1, 0.3], respectively. The order arrival is assumed to follow a Poisson distribution.

In this example, it is assumed that the probability of a case being selected by an order is equal for all the cases stored in the warehouse. After an order is assigned to an autonomous guided vehicle, the case retrieval order within a trip is randomly generated. Additionally, the case allocation between different trips is also randomly set. The autonomous guided vehicle's movement follows the path. The autonomous guided vehicle uses A* path planning algorithm described in F. Duchoň et al., ‘Path Planning with Modified a Star Algorithm for a Mobile Robot’, Procedia Engineering, vol. 96, pp. 59-69, January 2014, doi: 10.1016/j.proeng.2014.12.098.

A discrete event system model is built using AnyLogic® software. 10 replications are run with a running time of 1000 hours per replication, leading to a 95% confidence interval where the half-width is within 2% of the average.

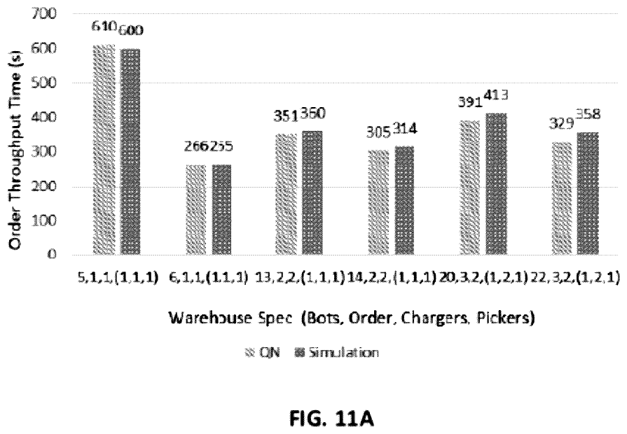

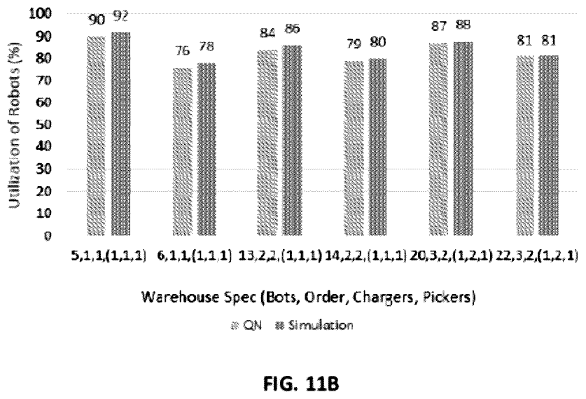

The steady-state performance (order throughput time and autonomous guided vehicle utilization) obtained from technology described herein and discrete event simulation with different warehouse resource specifications, including the number of autonomous guided vehicles, the number of chargers in the charging station, the number of pickers in different workstations, and the average order arrival rate per minute are compared. As shown in FIGS. 11A and 11B, the accuracy of the technology described herein for both order throughput time and autonomous guided vehicle utilization are above 90%.

Additionally, it takes an average of 300 seconds to obtain the steady-state performance through the discrete event simulation using AnyLogic® software. In the technology described herein, using AMVA method to solve the built SOQN only requires 0.1 sec, the computation time needed to calculate travel durations is about 15 seconds.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to explain the principles of the invention and its practical applications, they thereby enable others skilled in the art to utilize the invention and various embodiments with various modifications as are suited to the particular use contemplated. It is intended that the following claims and their equivalents define the scope of the invention.

1. A computer-implemented method of estimating performance of an autonomous robot system configured to fulfil multiple line orders, wherein the autonomous robot system comprises a plurality of autonomous guided vehicles configured to transport one or more cases within an environment so as to fulfil the multiple line orders, the method comprising:
obtaining, via a user interface, first input data, the first input data including data associated with operation of each of the plurality of autonomous guided vehicles and data representing a layout of the environment;
generating, based at least in part on the first input data, a simulation model configured to simulate the operation of each of the plurality of autonomous guided vehicles within the environment;
determining, based on an execution of the simulation model, a travel duration for each of the plurality of autonomous guided vehicles from a first location of one or more locations in the environment to a second location of the one or more locations in the environment;
generating, based at least in part on the travel duration, an analytical model configured to analyse the performance of the autonomous robot system; and
estimating, based on an execution of the analytical model, the performance of the autonomous robot system.

2. The computer-implemented method of claim 1, wherein estimating the performance of the autonomous robot system includes calculating a throughput time to fulfil the multiple line orders.

3. The computer-implemented method of claim 1, wherein estimating the performance of the autonomous robot system includes calculating a rate at which one or more resources in the environment are utilized to fulfil the multiple line orders.

4. The computer-implemented method of claim 1, wherein data associated with operation of each of the plurality of autonomous guided vehicles includes for each autonomous guided vehicle, at least one of:
an order in which the one or more cases are to be retrieved by the autonomous guided vehicle from an order queue,
an indication of how the many cases of the one or more cases are to be retrieved from the order queue in one trip, and
a moving speed of the autonomous guided vehicle.

5. The computer-implemented method of claim 1, wherein determining the travel duration includes:
for each of the plurality of the autonomous guided vehicles determining at least one of:
a first travel time from a current location of the autonomous guided vehicle to a location of the one or more cases,
a second travel time from the location of the one or more cases to a location of a workstation,
a third travel time from the location of the workstation to a storage location, and
a fourth travel time from the storage location to a charging location.

6. The computer-implemented method of claim 5, wherein determining the travel duration further comprises:
sampling the first travel time, the second travel time, the third travel time, and the fourth travel time for different type of multiple line orders; and
determining an average travel time based on the sampling.

7. The computer-implemented method of claim 1, wherein the analytical model is a shared-token multi-class semi-open queuing network.

8. The computer-implemented method of claim 7, wherein generating the analytical model further comprises:
representing a process of matching an autonomous guided vehicle of the plurality of autonomous guided vehicles to a first multiple line order as a first synchronization node;
representing a process of retrieving the one or more cases by the autonomous guided vehicle as a second infinite service node;
representing a process of traveling by the autonomous guided vehicle with the one or more retrieved cases to a workstation as a third infinite service node;
representing a process of a picker at the workstation retrieving a product from the one or more cases as a fourth service node; and
representing a process of traveling by the autonomous guided vehicle from the workstation to a storage location as a fifth infinite service node.

9. The computer-implemented method of claim 7, wherein estimating the performance of the autonomous robot system comprises performing an approximated mean value analysis of the shared-token multi-class semi-open queuing network.

10. A system for estimating performance of an autonomous robot system configured to fulfil multiple line orders, the system comprising:
a user interface to obtain first input data, wherein the first input data includes data associated with operation of each of a plurality of autonomous guided vehicles and data representing a layout of an environment, wherein the autonomous robot system comprises the plurality of autonomous guided vehicles configured to transport one or more cases within the environment so as to fulfil the multiple line orders; and
at least one controller communicably coupled to the user interface and configured to:
generate, based at least in part on the first input data, a simulation model configured to simulate the operation of each of the plurality of autonomous guided vehicles within the environment;
determine, based on an execution of the simulation model, a travel duration for each of the plurality of autonomous guided vehicles from a first location of one or more locations in the environment to a second location of the one or more locations in the environment;
generate, based at least in part on the travel duration, an analytical model configured to analyse the performance of the autonomous robot system; and
estimate, based on an execution of the analytical model, the performance of the autonomous robot system.

11. The system of claim 10, wherein the controller is configured to calculate a throughput time to fulfil the multiple line orders to estimate the performance of the autonomous robot system.

12. The system of claim 10, wherein the controller is configured to calculate a rate at which one or more resources in the environment are utilized to fulfil the multiple line orders so as to estimate the performance of the autonomous robot system.

13. The system of claim 10, wherein data associated with operation of each of the plurality of autonomous guided vehicles includes for each autonomous guided vehicle, at least one of:
an order in which the one or more cases are to be retrieved by the autonomous guided vehicle from an order queue,
an indication of how the many cases of the one or more cases are to be retrieved from the order queue in one trip, and
a moving speed of the autonomous guided vehicle.

14. The system of claim 10, wherein controller is further configured to:
for each of the plurality of the autonomous guided vehicles determine at least one of:
a first travel time from a current location of the autonomous guided vehicle to a location of the one or more cases,
a second travel time from the location of the one or more cases to a location of a workstation,
a third travel time from the location of the workstation to a storage location, and
a fourth travel time from the storage location to a charging location.

15. The system of claim 14, wherein the controller is further configured to:
sample the first travel time, the second travel time, the third travel time, and the fourth travel time for different type of multiple line orders; and
determine an average travel time based on the sampling.

16. The system of claim 10, wherein the analytical model is a shared-token multi-class semi-open queuing network.

17. The system of claim 16, wherein the controller is configured to:
represent a process of matching an autonomous guided vehicle of the plurality of autonomous guided vehicles to a first multiple line order as a first synchronization node;
represent a process of retrieving the one or more cases by the autonomous guided vehicle as a second infinite service node;
represent a process of traveling by the autonomous guided vehicle with the one or more retrieved cases to a workstation as a third infinite service node;
represent a process of a picker at the workstation retrieving a product from the one or more cases as a fourth service node; and
represent a process of traveling by the autonomous guided vehicle from the workstation to a storage location as a fifth infinite service node, thereby generating the analytical model.

18. The system of claim 16, wherein the controller is further configured to perform an approximated mean value analysis of the shared-token multi-class semi-open queuing network so as to estimate the performance of the autonomous robot system.
